(19) United States
(12) Patent Application Publication
(10) Pub. No.: US 2013/0078459 A1
(43) Pub. Date: Mar. 28, 2013

(54) CONDUCTIVE ADHESIVE MIXTURE, FLUORESCENT SCREEN ANODE PLATE AND THE MANUFACTURING METHODS THEREOF

(71) Applicants: Mingjie Zhou, Guangdong (CN); Wenbo Ma, Guangdong (CN); Qingtao Li, Guangdong (CN); Pengrui Shao, Guangdong (CN)

(72) Inventors: Mingjie Zhou, Guangdong (CN); Wenbo Ma, Guangdong (CN); Qingtao Li, Guangdong (CN); Pengrui Shao, Guangdong (CN)

(73) Assignee: Ocean's King Lighting Science & Technology Co., Ltd., Guangdong (CN)

(21) Appl. No.: 13/702,132

(22) PCT Filed: Jun. 9, 2010
(86) PCT No.: PCT/CN2010/073733

§ 371 Date: Dec. 5, 2012

(51) Int. Cl. H01B 1/06; H01B 1/02; B32B 9/00; H01B 1/08

(52) U.S. Cl. CPC H01B 1/06; H01B 1/08; H01B 1/02; B32B 9/00
USPC 428/336; 252/520.1; 252/521.3; 252/512; 428/690; 427/67

(57) ABSTRACT

A conductive adhesive mixture includes a component A which is 0.1% to 28% of the dry weight of the conductive adhesive mixture and a component B which is 72% to 99.9% of the dry weight of the conductive adhesive mixture. The component A is selected from one or more of the group consisting of SnCl₄, InCl₃ and SbCl₃; and the component B is selected from one or more of the group consisting of K₂O.nSiO₂, Na₂O.nSiO₂, (SiO₂)ₙ and Al₂O₃. The conductive adhesive mixture, having good electrical conductivity, is used for preparation of the fluorescent screen anode plate, greatly improving the life of the luminous layer, thus improving the life and light efficiency of the field emission device. The present invention further provides a fluorescent screen anode plate manufactured with this conductive adhesive mixture and the manufacturing method thereof.

### FIELD OF THE INVENTION

The present invention relates to vacuum microelectronics technologies, and especially to a conductive adhesive mixture, a fluorescent screen anode plate and manufacturing methods thereof.

### BACKGROUND OF THE INVENTION

The cathodoluminescence device, particularly the field emission light source, has such advantages as energy saving, environmental protection, fast starting, being thin and light, as well as strong environmental adaptability. In the era of vigorously advocating energy saving and environmental protection, it has become an important research topic in various countries as an environmental lighting source and has huge development potential.

The field emission light can be applied to the lighting source and information terminal display device. The structure of the field emission luminous device is mainly composed of a cathode electron source and an anode luminous screen. The anode luminous screen is composed of a glass substrate, a conductive layer and a luminous layer. The luminous layer can be made of luminous materials, such as thin film, luminous glass or phosphor. The commonly used at present is the phosphor luminous material. The phosphor layer is manufactured mainly by such process methods as the deposition method, the screen printing method or the electrophoresis method, making the substrate coated with a luminous layer having a proper thickness and a smooth surface. The produced fluorescent screen usually works under conditions of large current and low voltage.

The fluorescent screen anode plate generally uses the phosphor as the luminous layer; the oxide phosphor, having poor electrical conductivity, is prone to resulting in the anode charge accumulation, thus causing such problems as voltage drop, lowering the luminous efficiency of the device.

### SUMMARY OF THE INVENTION

In view of this, it is an object of this invention to provide a conductive adhesive mixture that can improve electrical conductivity of the fluorescent screen anode plate, as well as a fluorescent screen anode plate manufactured with this conductive adhesive mixture.

Besides, it is another object of this invention to provide a method of manufacturing the conductive adhesive mixture and the fluorescent screen anode plate.

A conductive adhesive mixture, comprising a component A and a component B, wherein the amount of the component A is 0.1% to 28% of the dry weight of the conductive adhesive mixture; the component A is selected from one or more of the group consisting of SnCl₄, InCl₃ and SbCl₃; and
the amount of the component B is 72% to 99.9% of the dry weight of the conductive adhesive mixture, the component B is selected from one or more of the group consisting of K₂O.nSiO₂, Na₂O.nSiO₂, (SiO₂)ₙ and Al₂O₃.

Preferably, the conductive adhesive mixture further comprising a component C, the amount of the component C is 0.05% to 2% of the dry weight of the conductive adhesive mixture, and the component C is selected from one or two of the group consisting of Sn nanoparticles and In nanoparticles.

It is another object of the present invention is to provide a method of preparation of the conductive adhesive mixture:

Providing the component A of 0.1% to 28% by weight and the component B of 72% to 99.9% by weight; wherein the component A is selected from one or more of the group consisting of SnCl₄, InCl₃ and SbCl₃, and the component B is selected from one or more of the group consisting of K₂O.nSiO₂, Na₂O.nSiO₂, (SiO₂)ₙ or Al₂O₃; and mixing the component A and the component B together, adding deionized water, and subjecting the mixture to ultrasonic waves for 25 to 35 minutes to produce the conductive adhesive mixture.

A fluorescent screen anode plate manufactured with the above conductive adhesive mixture is provided, comprising: a substrate having a conductive layer; and a phosphor layer located on the conductive layer, wherein the fluorescent screen anode plate further comprises a conductive adhesive layer coated on a surface of the phosphor layer and formed by the conductive adhesive mixture.

Preferably, the thickness of the conductive adhesive layer is in a range of 0.1 to 2 μm.

A method of manufacturing the fluorescent screen anode plate, comprising the following steps:

S1: coating a phosphor onto a conductive layer of a substrate to form a phosphor layer;

S2: coating the conductive adhesive mixture onto the phosphor layer to form a conductive adhesive layer; and

S3: drying and heat-treating the conductive adhesive layer to obtain the fluorescent screen anode plate.

Preferably, in Step S1, the substrate with the conductive layer is an indium-tin oxide glass (i.e. the ITO glass); the phosphor is the yttrium terbium silicate green phosphor, the yttrium europium oxide red phosphor or the yttrium cerium silicate blue phosphor; the phosphor is coated onto the conductive layer of the substrate by the deposition or screen printing method to form the phosphor layer, and the phosphor layer is heat treated at 450° C. for from 30 minutes to 2 hours after the formation thereof on the conductive layer of the substrate; in Step S2, the conductive adhesive mixture is coated onto the surface of the phosphor layer by an infiltration or spincoating method; in Step S3, the drying temperature is from 45° C. to 55° C., the heat treatment temperature is from 120° C. to 200° C., and the heat treatment duration is from 30 minutes to 10 hours.

In the conductive adhesive mixture, the component A is selected from one or more of the group consisting of SnCl₄, InCl₃ and SbCl₃, and the component B is selected from one or more of the group consisting of K₂O.nSiO₂, Na₂O.nSiO₂, (SiO₂)ₙ and Al₂O₃, and the conductive adhesive mixture formed by mixing them has good electrical conductivity. When the conductive adhesive mixture is applied to the fluorescent screen anode plate, the electrical conductivity of the phosphor layer and the service life of the anode plate are improved. It is significant for accelerating commercialization of the cold cathode light source and field emission flat-panel display devices to improve the service life and light efficiency of the field emission device.

The component C is selected from one or two of the group consisting of Sn nanoparticles and In nanoparticles, which further improves electrical conductivity of the conductive adhesive mixture after being added into the conductive adhesive mixture. The ratio of the components of the conductive adhesive mixture can be adjusted, and thus different conductive adhesive mixtures can be prepared with different properties, and the range of application is greatly expanded.

In addition, the process of manufacturing the conductive adhesive mixture and the fluorescent screen anode plate is simple and has a low requirement for facilities, and is thus easy to be popularized.

### BRIEF DESCRIPTION OF THE DRAWINGS

FIG. 1 is a schematic structural view of a fluorescent screen anode plate.

FIG. 2 is a flow chart of the method for manufacturing the fluorescent screen anode plate.

### DETAILED DESCRIPTION

A conductive adhesive mixture is prepared by mixing component A, the component B and the ionized water and subjecting the mixture to ultrasonic waves for 25 to 35 minutes, where the amount of the component A is 0.1% to 28% of the dry weight of the conductive adhesive mixture, and the amount of the component B is 72% to 99.9% of the dry weight of the conductive adhesive mixture. The component A is selected from one or more of the group consisting of SnCl₄, InCl₃ and SbCl₃, and the component B is selected from one or more of the group consisting of K₂O.nSiO₂, Na₂O.nSiO₂, (SiO₂)ₙ and Al₂O₃.

In a preferred embodiment, the conductive adhesive mixture further includes a component C, which is selected from one or more of the group consisting of Sn nanoparticles and In nanoparticles. The addition of the component C allows electrical conductivity of the conductive adhesive mixture to be further improved.

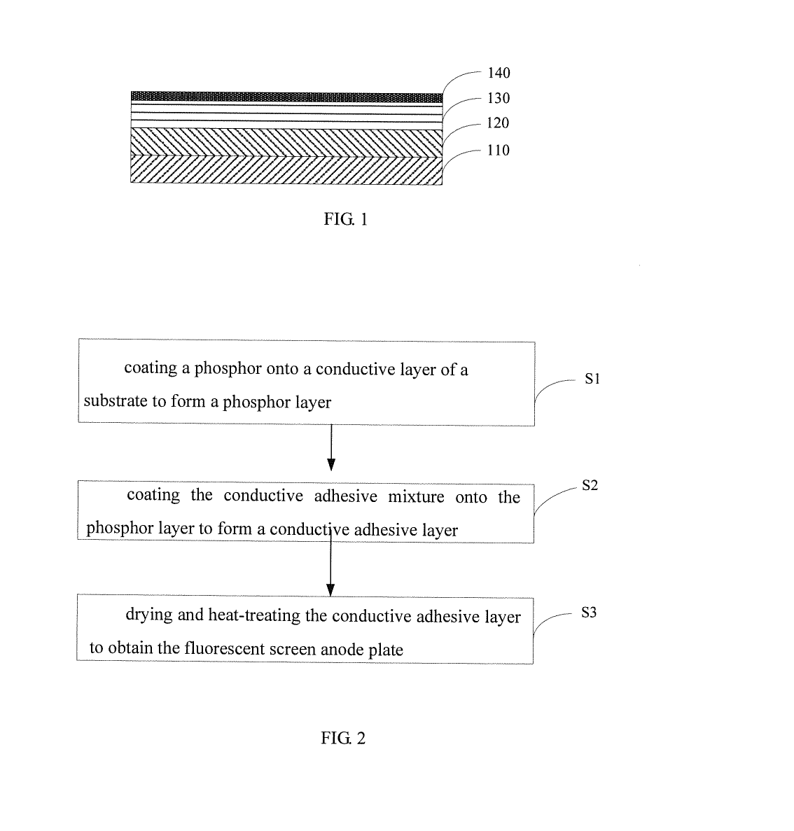

A fluorescent screen anode plate as shown in FIG. 1 includes a substrate 110, a conductive layer 120 formed on a surface of the substrate 110, and a phosphor layer 130 located on the conductive layer 120. In addition, the fluorescent screen anode plate further includes a conductive adhesive layer 140 having good electrical conductivity coated on a surface of the phosphor layer 130 and formed by the above-mentioned conductive adhesive mixture. The conductive adhesive layer 140 has a thickness of 0.1-2 μm.

A method of manufacturing the fluorescent screen anode plate as shown in FIG. 2 includes the following steps:

S1: The phosphor is coated onto the conductive layer of the substrate to form the phosphor layer;

S2: the conductive adhesive mixture is coated onto the phosphor layer to form the conductive adhesive layer; and

S3: the conductive adhesive layer is dried and heat-treated to obtain the fluorescent screen anode plate.

Preferably, in Step S1, the substrate is an ITO glass. Step S1 further includes: the phosphor layer is heat treated at 450° C. for 30 minutes to 2 hours after the formation on the conductive layer of the substrate; and the phosphor is coated onto a conductive layer by a deposition or screen printing method. In Step S2, the conductive adhesive mixture is coated onto the surface of the phosphor layer by an infiltration or spincoating method to form the conductive adhesive layer. In Step S3, the drying temperature is 45° C.-55° C., the heat treatment temperature is 120° C.-200° C., and the heat treatment duration is from 30 minutes to 10 hours.

In a preferred embodiment, the conductive adhesive mixture includes a component A, a component B, and a component C. The component A is conductive hydrochloride, the component B is silicate salt, (SiO₂)ₙ or Al₂O₃, and the component C is Sn nanoparticles and In nanoparticles, and the conductive adhesive mixture formed by mixing the three components has good electrical conductivity. The conductive adhesive mixture is coated onto the phosphor layer of the fluorescent screen anode plate by an infiltration or spincoating method, thus forming the conductive adhesive layer with a thickness of 0.1-2 μm. When the conductive adhesive mixture is applied to the fluorescent screen anode plate, the electrical conductivity of the phosphor layer and the service life of the anode plate are improved. It is significant for accelerating commercialization of the cold cathode light source and field emission flat-panel display devices to improve the service life and light efficiency of the field emission device.

The ratio of the three components of the conductive adhesive mixture can be adjusted, and thus different conductive adhesive mixtures can be prepared with different properties, and the range of application is greatly expanded.

In addition, the process of manufacturing the conductive adhesive mixture and the fluorescent screen anode plate is simple and has a low requirement for facilities, and is thus easy to be popularized.

The conductive adhesive mixture, the fluorescent screen anode plate and the manufacturing methods thereof of the present invention will further be described below mainly with reference to the specific examples.

### Example 1

Preparation of the conductive adhesive mixture: 28 g of SnCl₄, 70 g of potassium silicate, 700 ml of ionized water, and 2 g of Sn nanoparticles were mixed together, and then the mixture was subjected to ultrasonic waves for 30 minutes to produce the conductive adhesive mixture.

An ITO glass was cut according to a predetermined size, and then washed with acetone, alcohol and deionized water, respectively. After the ITO glass was dried, a yttrium terbium silicate green phosphor was deposited onto an ITO surface of the ITO glass to form a phosphor layer, and then the ITO glass was heat-treated at 450° C. for 30 minutes. Finally, a conductive adhesive was coated onto the surface of the phosphor layer by the spincoating process and dried at a low temperature of 45° C., and the conductive adhesive was heat treated at 120° C. for 5 hours to obtain the fluorescent screen anode plate. The conductive adhesive layer therein had a thickness of about 0.1

### Example 2

Preparation of the conductive adhesive mixture: 4.5 g of InCl₃ solution, 95 g of sodium silicate, 600 ml of ionized water, and 0.5 g of In nanoparticles were mixed together, and then the mixture was subjected to ultrasonic waves for 30 minutes to produce the conductive adhesive mixture.

An ITO glass was cut according to a predetermined size, and then washed with acetone, alcohol and deionized water, respectively. After the ITO glass is dried, an yttrium europium oxide red phosphor was deposited onto an ITO surface of the ITO glass to form a phosphor layer, and then the ITO glass was heat-treated at 450° C. for 1 hour. Finally, a conductive adhesive was coated onto the surface of the phosphor layer by the infiltration process and dried at a low temperature of 50° C., and the conductive adhesive was heat treated at 150° C. for 2 hours to obtain the fluorescent screen anode plate. The conductive adhesive layer therein had a thickness of about 2 μm.

### Example 3

Preparation of the conductive adhesive mixture: 28 g of SbCl₃, 72 g of poly(silicon dioxide), and 350 ml of deionized water were mixed together, and then the mixture was subjected to ultrasonic waves for 30 minutes to produce the conductive adhesive mixture.

An ITO glass was cut according to a predetermined size, and then washed with acetone, alcohol and deionized water, respectively. After the ITO glass was dried, an yttrium europium oxide red phosphor was deposited onto an ITO surface of the ITO glass to form a phosphor layer, and then the ITO glass was heat-treated at 450° C. for 2 hours. Finally, a conductive adhesive was coated onto the surface of the phosphor layer by the spincoating process and dried at a low temperature of 50° C., and the conductive adhesive was heat treated at 130° C. for 5 hours to obtain the fluorescent screen anode plate. The conductive adhesive layer therein had a thickness of about 1 μm.

### Example 4

Preparation of the conductive adhesive mixture: 14 g of SbCl₃, 6 g of InCl₃ solution, 80 g of poly(silicon dioxide), and 600 ml of deionized water were mixed together, and then the mixture was subjected to ultrasonic waves for 30 minutes to produce the conductive adhesive mixture.

An ITO glass was cut according to a predetermined size, and then washed with acetone, alcohol and deionized water, respectively. After the ITO glass is dried, a yttrium cerium silicate blue phosphor was deposited onto an ITO surface by the deposition method to form a phosphor layer, and then the ITO glass was heat-treated at 450° C. for 30 minutes. Finally, a conductive adhesive was coated onto the surface of the phosphor layer by the infiltration process and dried at a low temperature of 50° C., and the conductive adhesive was heat treated at 130° C. for 10 hours to obtain the fluorescent screen anode plate. The conductive adhesive layer therein had a thickness of about 1.5 μm.

### Example 5

Preparation of the conductive adhesive mixture: 1.5 g of InCl₃ solution, 0.1 g of SnCl₄, 98 g of sodium silicate, 600 ml of ionized water, and 0.4 g of Sn nanoparticles were mixed together, and then the mixture was subjected to ultrasonic waves for 30 minutes to produce the conductive adhesive mixture.

An ITO glass was cut according to a predetermined size, and then washed with acetone, alcohol and deionized water, respectively. After the ITO glass was blown dry with an inert gas, a yttrium europium oxide red phosphor was deposited onto an ITO surface by the screen printing method to form the phosphor layer, and then the ITO glass was heat-treated at 450° C. for 2 hours. Finally, a conductive adhesive was coated onto the surface of the phosphor layer by the spincoating process and dried at a low temperature of 50° C., and the conductive adhesive was at 150° C. for 3 hours to obtain the fluorescent screen anode plate. The conductive adhesive layer therein had a thickness of about 1.5 μm.

### Example 6

Preparation of the conductive adhesive mixture: 27 g of SnCl₄, 71 g of aluminum oxide, 650 ml of ionized water, and 2 g of Sn nanoparticles were mixed together, and the mixture was subjected to ultrasonic waves for 30 minutes to produce the conductive adhesive mixture.

An ITO glass was cut according to a predetermined size, and then washed with acetone, alcohol and deionized water, respectively. After the ITO glass was blown dry with an inert gas, an yttrium europium oxide red phosphor was deposited onto an ITO surface by the screen printing method to form the phosphor layer, and then the ITO glass was heat-treated at 450° C. for 2 hours. Finally, a conductive adhesive was coated onto the surface of the phosphor layer by the infiltration process and dried at a low temperature of 55° C., and the conductive adhesive was heat treated at 150° C. for 5 hours to obtain the fluorescent screen anode plate. The conductive adhesive layer therein had a thickness of about 0.8 μm.

Although the invention has been described in language specific to structural features and/or methodological acts, it is to be understood that the invention defined in the appended claims is not necessarily limited to the specific features or acts described. Rather, the specific features and acts are disclosed as sample forms of implementing the claimed invention.

What is claimed is:

1. A conductive adhesive mixture, comprising a component A and a component B, wherein
the amount of the component A is 0.1% to 28% of the dry weight of the conductive adhesive mixture; the component A is selected from one or more of the group consisting of SnCl₄, InCl₃ and SbCl₃; and
the amount of the component B is 72% to 99.9% of the dry weight of the conductive adhesive mixture, the component B is selected from one or more of the group consisting of K₂O.nSiO₂, Na₂O.nSiO₂, (SiO₂)ₙ and Al₂O₃.

2. The conductive adhesive mixture according to claim 1, further comprising a component C, the amount of the component C is 0.05% to 2% of the dry weight of the conductive adhesive mixture, and the component C is selected from one or two of the group consisting of Sn nanoparticles and In nanoparticles.

3. A method of preparing the conductive adhesive mixture, comprising the following steps:
providing the component A of 0.1% to 28% by weight and the component B of 72% to 99.9% by weight; wherein the component A is selected from one or more of the group consisting of SnCl₄, InCl₃ and SbCl₃, and the component B is selected from one or more of the group consisting of K₂O.nSiO₂, Na₂O.nSiO₂, (SiO₂)ₙ and Al₂O₃; and
mixing the component A and the component B together, adding deionized water, and subjecting the mixture to ultrasonic waves for 25 to 35 minutes to produce the conductive adhesive mixture.

4. A fluorescent screen anode plate manufactured with the conductive adhesive mixture according to claim 1, comprising:
a substrate having a conductive layer; and
a phosphor layer located on the conductive layer, wherein the fluorescent screen anode plate further comprises a conductive adhesive layer coated on a surface of the phosphor layer and formed by the conductive adhesive mixture.

5. The fluorescent screen anode plate according to claim 4, wherein the thickness of the conductive adhesive layer is in a range of 0.1 to 2 μm.

6. A method of manufacturing the fluorescent screen anode plate according to claim 4, comprising the following steps:
S1: coating a phosphor onto a conductive layer of a substrate to form a phosphor layer;
S2: coating the conductive adhesive mixture onto the phosphor layer to form a conductive adhesive layer; and
S3: drying and heat-treating the conductive adhesive layer to obtain the fluorescent screen anode plate.

7. The method of manufacturing the fluorescent screen anode plate according to claim 6, wherein in Step S1, the substrate is an indium-tin oxide glass; and the phosphor is yttrium terbium silicate green phosphor, yttrium europium oxide red phosphor or yttrium cerium silicate blue phosphor.

8. The method of manufacturing the fluorescent screen anode plate according to claim 6, wherein Step S1 further comprises: the phosphor layer is heat treated at 450° C. for 30 minutes to 2 hours after the formation thereof on the conductive layer of the substrate; and the phosphor is coated onto the conductive layer by a deposition or screen printing method.

9. The method of manufacturing the fluorescent screen anode plate according to claim 6, wherein in Step S2, the conductive adhesive mixture is coated onto the surface of the phosphor layer by an infiltration or spincoating method.

10. The method of manufacturing the fluorescent screen anode plate according to claim 6, wherein in Step S3, the drying temperature is from 45° C. to 55° C., the heat treatment temperature is from 120° C. to 200° C., and the heat treatment duration is from 30 minutes to 10 hours.
